(19) United States
(12) Patent Application Publication
(10) Pub. No.: US 2006/0203784 A1
(43) Pub. Date: Sep. 14, 2006

(54) Smart roaming to avoid time-outs during WLAN association

(75) Inventors: Daryl Carvis Cromer, Apex, NC (US); Philip John Jakes, Durham, NC (US); Howard Jeffrey Locker, Cary, NC (US); Randall Scott Springfield, Chapel Hill, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/079,329

(22) Filed: Mar. 14, 2005

(51) Int. Cl. H04Q 7/24

(52) U.S. Cl. 370/338

(57) ABSTRACT

A method and system for wirelessly connecting a client device to a wireless network's access point. When a first client device detects a Wireless Broadcast Storm During Active Scan Association (WBSDAASA) caused by a large block of other client devices attempting to simultaneously wirelessly connect to the access point using an active scan, the first client device switches to either a passive scan or a random roam active scan to connect the first client device to the access point. The first client device is thus able to avoid a connection live-lock caused by the WBSDAASA.

### BACKGROUND OF THE INVENTION

1. Technical Field

The present invention relates in general to the field of computers, and in particular to client devices in a Wireless Local Area Network (WLAN). Still more particularly, the present invention relates to a method and system for logically connecting a wireless client device to a WLAN's access point while multiple other wireless computing devices are simultaneously attempting to connect to the WLAN's access point.

2. Description of the Related Art

Early computers were stand-alone devices. Each computer had its own memory (primary and mass storage), data input device (usually a card or tape reader), and data output device (printer and/or monitor). In an effort to share computing power and resources, later computers were linked together in hard-wired networks, which were usually Local Area Networks (LANs). Besides computers, other client devices, including input/output devices such as printers, secondary storage devices, etc., were connected to LANs. Each client device would access the hard-wired LAN through an access point (gateway), such that there was a dedicated link between the access point (access device) and each client device. Per various IEEE (Institute of Electrical and Electronics Engineers) specifications, a link from a client device to the network via an access device (bridge, router, gateway, etc.) was ensured to occur within three seconds.

The next generation of networks, and particularly LANs, were Wireless LANs (WLANs). The standard protocols used to connect client devices to WLANs are found in the IEEE 802.11 series of standards (often referred to as “Wireless Fidelity” or simply “Wi-Fi”).

IEEE 802.11a provides for data transmission rates up to 54 Mbps (Megabits per second) in the 5 GHz (5 GigaHertz radio frequency) band. Under IEEE 802.11a, mandatory data transmission rates are at 6, 12 and 24 Mbps, and additional supported rates are found at 9, 18, 36, 48 and 54 Mbps rates. Although IEEE 802.11a devices have a relatively short range and only eight available channels, IEEE 802.11a is still popular for some implementations since it has less potential for Radio Frequency (RF) interference than other 802.11 protocols.

IEEE 802.11b provides for data transmission rates up to 11 Mbps in the 2.4 GHz radio band. Data is transmitted at 1 and 2 Mbps under standard Barker code, and at 5.5 and 11 Mbps using Complementary Code Keying (CCK), which is a set of 64 eight-bit code words used to encode data to represent a greater volume of information per clock cycle. IEEE 802.11b devices require fewer access points since the range of IEEE 802.11b devices is greater than that of IEEE 802.11a devices. IEEE 802.11b devices have a range of up to 300 feet, and 14 total channels (of which only 11 are available in the United States due to Federal Communications Commission (FCC) regulations).

IEEE 802.11g provides for data transmission rates up to 54 Mbps in the 2.4 GHz band, and provides improved security enhancements over IEEE 802.11b across 11 available channels. IEEE 802.11g provides backward compatibility with the 802.11b standard by supporting the 802.11b specified data rates of 1, 2, 5.5 and 11 Mbps. IEEE 802.11g also adds further data rates of 6, 9, 12, 18, 24, 36, 48 and 54 Mbps using Orthogonal Frequency Division Multiplexing (OFDM) modulation, which splits the radio signal into multiple smaller sub-signals that are then transmitted simultaneously at different frequencies to a receiver (using Binary or Quadrature Phase Shift Keying (BPSK/QPSK), 16-Quadrature Amplitude Modulation (16-QAM) or 64-Quadrature Amplitude Modulation (64-QAM)).

Connecting a client device to a WLAN is much more complex than connecting a client device to a hard-wired LAN, since the client device must scan to determine if a WLAN is present and to determine which wireless channels are active. This process of association and authentication can be performed using either a passive scan or an active scan.

Passive scans are highly reliable, and only require the client device to passively sit and listen for beacon frames transmitted from an access point. Typically, the client device will listen to the highest frequency available first. For example, assuming that the client device is 802.11a enabled (and thus has backwards capability with 802.11g and 802.11b). That client device will first listen in on the 5 GHz (802.11a) band, starting with Channel 1 (e.g., at 6 Mbps). If the client device hears nothing on Channel 1, then it moves to Channel 2, and then to Channel 3, etc. until it has listened to all eight channels in the 5 GHZ band. The client device then moves to the 802.11g channels in the 2.4 GHz band, listening to each of the available 11 channels in sequence. Finally, the client device listens to the 802.11b channels in the 2.4 GHz band. Scanning (listening to) all three modes (802.11a, g and b) having a total of 30 channels requires over a minute. To speed up the process of connecting a client device to the access point, active scans were introduced.

In an active scan, a client device broadcasts a probe request (for a particular channel on a specified band) to the access point. If the access point hears the probe request, it replies with a probe response, letting the client device know that the requested channel (on the specified band) is available, and a communication association between the client device and the access point is established.

While an active association works well if only one or a few client devices are probing the access point, problems arise in environments in which numerous client devices are trying to establish simultaneous associations. For example, consider a college classroom in which there are 300 students, each of whom has a wireless client device such as a laptop computer or a Personal Digital Assistant (PDA). At the beginning of class, the professor instructs all of the students to log into the university's Wi-Fi network. Because active association is usually faster than passive association, each student initiates an active association log-in. Thus, the 300 students will all be trying to log into the same band (usually 5 GHz) and the same channels (the first few 801.11a channels). This scenario is known (defined) as “Wireless Broadcast Storm During Active Scan Association,” or WBSDAASA. WBSDAASA causes a live-lock error in the WLAN access point, due to the WLAN access point being overwhelmed by the numerous active scans. The live-lock problem caused by WBSDAASA does not resolve itself, since large blocks of client devices will move together (as a single block) from channel to channel, as described above in the active scan discussion, thus live-locking each channel to which the block moves.

What is needed, therefore, is a method and system that allows a client device to recognize a WBSDAASA, and to then initiate an alternate connection scheme with the access point to avoid the access point live-lock caused by the WBSDAASA.

### SUMMARY OF THE INVENTION

The present invention is thus directed to a method and system for wirelessly connecting a client device to a wireless network's access point. When a first client device detects a Wireless Broadcast Storm During Active Scan Association (WBSDAASA) caused by a large block of other client devices attempting to simultaneously wirelessly connect to the access point using an active scan, the first client device switches to either a passive scan or a random roam active scan to connect the first client device to the access point. The first client device is thus able to avoid a connection live-lock caused by the WBSDAASA.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an exemplary computer system in which the present invention can be implemented;

FIG. 2 illustrates a Wireless Local Area Network (WLAN) in which the exemplary computer system shown in FIG. 1 may be wirelessly connected; and

FIG. 3 is a flow chart of steps taken in a preferred embodiment of the present invention.

### DETAILED DESCRIPTION OF THE PREFERRED EMBODIMENT

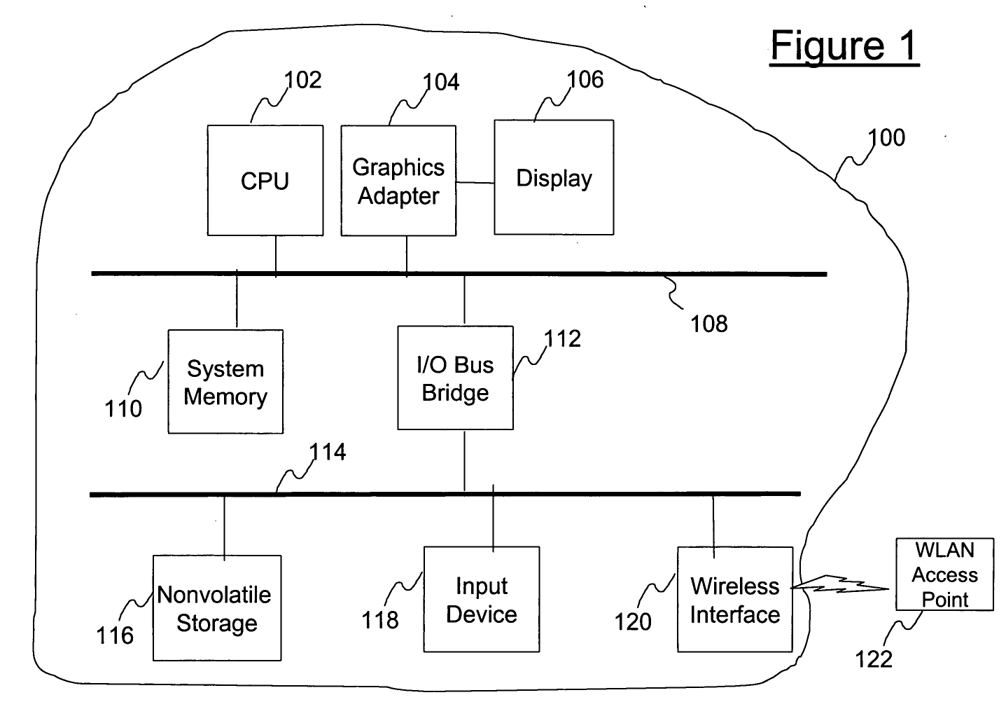

With reference now to FIG. 1, there is depicted a block diagram of a data processing system in which a preferred embodiment of the present invention may be implemented. Data processing system 100 represents an exemplary hardware configuration of a client device. Data processing system 100 may be, for example, a Personal Digital Assistant (PDA) or one of the models of laptop computers available from International Business Machines Corporation of Armonk, N.Y. Data processing system 100 includes a central processing unit (CPU) 102, which is connected to a system bus 108. In the exemplary embodiment, data processing system 100 includes a graphics adapter 104 also connected to system bus 108, for providing user interface information to a display 106.

Also connected to system bus 108 are a system memory 110 and an input/output (I/O) bus bridge 112. I/O bus bridge 112 couples an I/O bus 114 to system bus 108, relaying and/or transforming data transactions from one bus to the other. Peripheral devices such as nonvolatile storage 116, which may be a hard disk drive, and input device 118, which may include a conventional mouse, a trackball, a stylus pen, a touchpad, or the like, is connected to I/O bus 114.

Data processing system 100 also includes a wireless interface 120. Wireless interface 120 is an interface that permits data processing system 100 to wirelessly be incorporated into a Wireless Local Area Network (WLAN) (not shown) via a WLAN access point 122. Thus, WLAN access point 122 provides a wireless interface between data processing system 100 and other devices (not shown) connected to the WLAN.

The exemplary embodiment shown in FIG. 1 is provided solely for the purposes of explaining the invention and those skilled in the art will recognize that numerous variations are possible, both in form and function. For instance, data processing system 100 might also include a compact disk read-only memory (CD-ROM) or digital versatile disk (DVD) drive, a sound card and audio speakers, and numerous other optional components. All such variations are believed to be within the spirit and scope of the present invention.

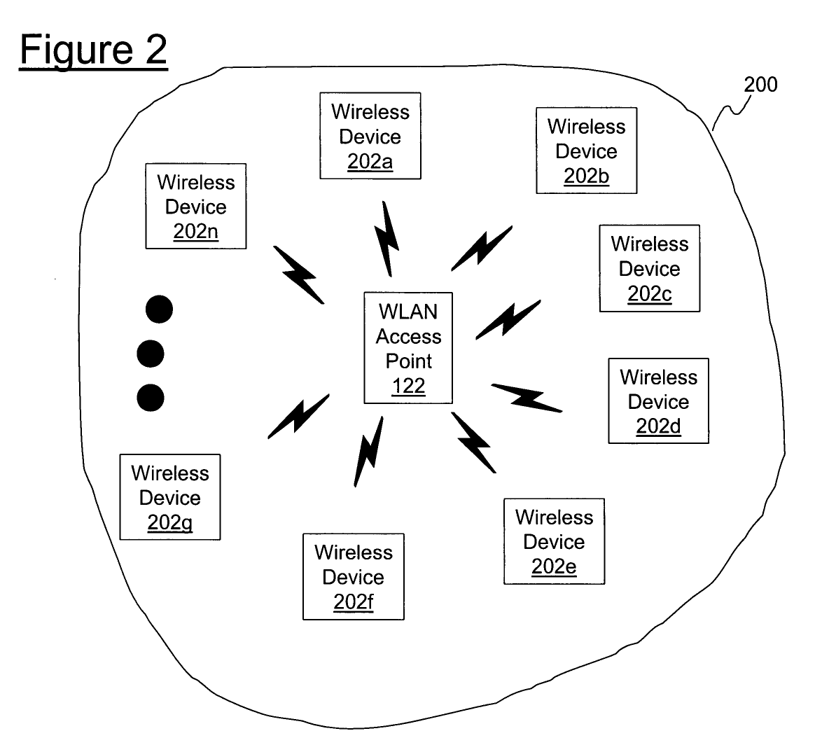

With reference now to FIG. 2, there is illustrated an exemplary Wireless Local Area Network (WLAN) 200, which includes WLAN access point 122, as well as multiple wireless devices 202. For the sake of illustration, assume that wireless device 202a is data processing system 100 shown in FIG. 1. Note, however, that each wireless devices 202 may be any wireless device, including a laptop computer, a Personal Digital Assistant (PDA), a Wi-Fi enabled cell phone, etc. Note also that there may be hundreds of wireless devices 202 in WLAN 200, such as described above with reference to the college classroom scenario.

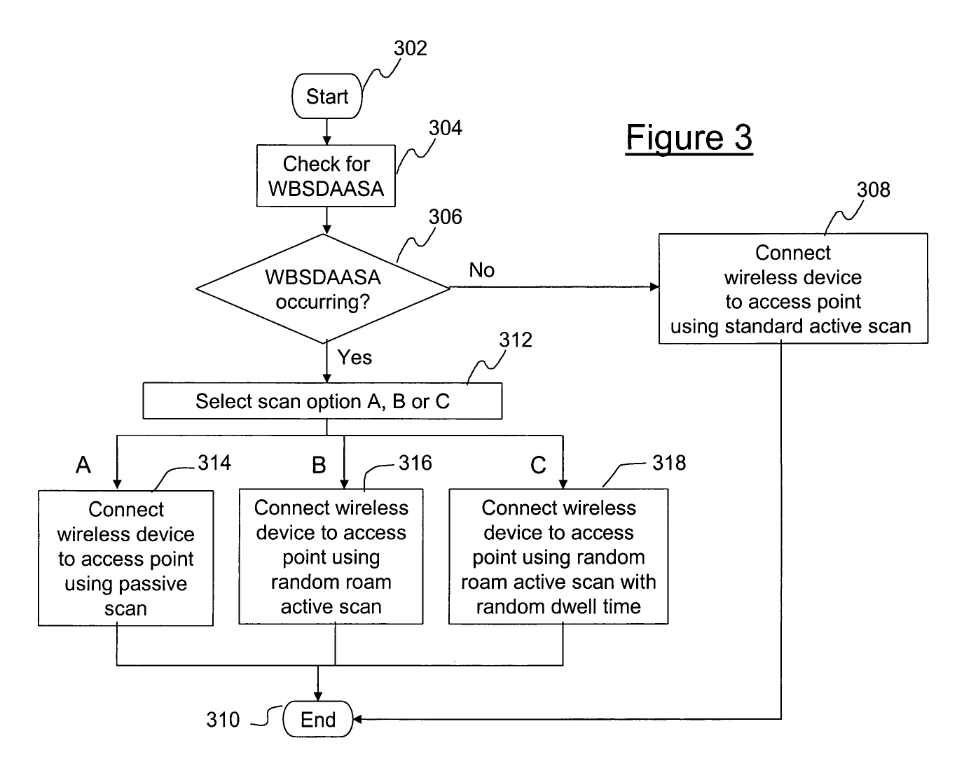

Referring now to FIG. 3, a flow-chart showing preferred steps taken by the present invention is presented. After initiator block 302, a check is made at block 304 for a Wireless Broadcast Storm During Active Scan Association (WBSDAASA), which is defined above as a condition in which multiple wireless devices attempt to simultaneously associate with a WLAN access point, causing an overload error to occur in the WLAN access point. Preferably, this is accomplished by, while a first client device listens for a response to a scan request, the first client device detects a large number of scan requests from other client devices. This large number of scan requests is recognized as a WBSDAASA event. If no WBSDAASA event is occurring (query block 306), then a wireless device (such as wireless device 202a) will, connect to the access point 122 (shown in FIGS. 1 and 2) using the standard active scan process (block 308) described above, and the process ends (terminator block 310).

However, if a WBSDAASA is occurring, then an alternate connection scheme between wireless device 202a and WLAN access point 122 is selected (block 312). For example, wireless device 202a may initiate a passive scan to associate and connect with WLAN access point 122 (block 314).

Alternatively, wireless device 202a may initiate a random roam active scan (block 316) to wirelessly connect with WLAN access point 122. A random roam active scan is defined as an alternate connection scheme that randomly channel hops between different channels (and optionally between different bands) to find a channel that is not flooded with connection requests. That is, during a WBSDAASA, most of the other wireless devices 202b-n will be trying to access the first few channels of a particular band. Random roam active scan allows wireless device 202a to randomly hop to other channels (and optionally other bands) in order to find a channel that is available for association.

As shown in block 318, the random roam active scan can be modified to incorporate random dwell time. That is, while randomly hopping from channel to channel looking for an open channel with which the wireless device 202a and WLAN access point 122 can wirelessly connect, wireless device 202a moves from channel to channel at random time intervals, thus increasing the likelihood of an open window of time during which a channel is accessible.

The selection shown in block 312 may be initiated automatically by a software program running in client device 202a (i.e., data processing system 100), or a Graphical User Interface (GUI) may present a manual selection option to a user. Whether manual or automatic, the alternate connection scheme is preferably selected using selection logic that is part of client device 202a. This selection logic may be part of CPU 102 shown in FIG. 1, or may be a dedicated logic such as an Application Specific Integrated Circuit (ASIC), (not shown in FIG. 1) within client device 202a.

The present device thus provides a novel method and system for avoiding an association live-lock when numerous wireless devices are attempting to simultaneously log into a WLAN. While the present invention has been described for use with laptops and similar computing devices, it may also be used with any WLAN enable device, including Wi-Fi enable cellular phones, peripheral devices such as printers and storage devices, etc.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method comprising:
monitoring for a Wireless Broadcast Storm During Active Scan Association (WBSDAASA); and
upon detecting the WBSDAASA, using an alternate connection scheme to wirelessly connect a client device to an access point of a wireless network.

2. The method of claim 1, wherein the alternate connection scheme passively listens at the client device for a beacon from the access point.

3. The method of claim 1, wherein the alternate connection scheme uses a random roam active scan to actively detect an available channel for connecting the client device with the access point.

4. The method of claim 3, wherein the random road active scan uses a random dwell time that causes the client device to actively scan different channels for different lengths of time.

5. The method of claim 1, wherein the monitoring step is performed by the client device.

6. The method of claim 1, wherein the wireless network is a Wireless Local Area Network (WLAN).

7. A system comprising:
a wireless device for monitoring a Wireless Local Area Network (WLAN) for a Wireless Broadcast Storm During Active Scan Association (WBSDAASA); and
selection logic in the wireless device for, upon detecting the WBSDAASA, choosing an alternate connection scheme to wirelessly connect a client device to an access point of a wireless network.

8. The system of claim 7, wherein the alternate connection scheme passively listens at the client device for a beacon from the access point.

9. The system of claim 7, wherein the alternate connection scheme uses a random roam active scan to actively detect an available channel for connecting the client device with the access point.

10. The system of claim 9, wherein the random road active scan uses a random dwell time that causes the client device to actively scan different channels for different lengths of time.

11. The system of claim 7, wherein the wireless network is a Wireless Local Area Network (WLAN).

12. A computer program product, residing on a computer usable medium, comprising:
program code for monitoring for a Wireless Broadcast Storm During Active Scan Association (WBSDAASA); and
program code for, upon detecting the WBSDAASA, using an alternate connection scheme to wirelessly connect a client device to an access point of a wireless network.

13. The computer program product of claim 12, wherein the alternate connection scheme passively listens at the client device for a beacon from the access point.

14. The computer program product of claim 12, wherein the alternate connection scheme uses a random roam active scan to actively detect an available channel for connecting the client device with the access point.

15. The computer program product of claim 14, wherein the random road active scan uses a random dwell time that causes the client device to actively scan different channels for different lengths of time.

16. The computer program product of claim 12, wherein the monitoring step is performed by the client device.

17. The computer program product of claim 12, wherein the wireless network is a Wireless Local Area Network (WLAN).
